(19) United States
(12) Patent Application Publication
(10) Pub. No.: US 2019/0213529 A1
(43) Pub. Date: Jul. 11, 2019

(54) NETWORK COMPUTER SYSTEM TO EVALUATE FREIGHT LOADS

(71) Applicant: Uber Technologies, Inc., San Francisco, CA (US)

(72) Inventors: Richard Donnelly, Pittsburgh, PA (US); Clifford Shaun Webb, Pittsburgh, PA (US)

(21) Appl. No.: 16/240,647

(22) Filed: Jan. 4, 2019

Related U.S. Application Data
(60) Provisional application No. 62/613,872, filed on Jan. 5, 2018.

(51) Int. Cl. G06Q 10/08; G06Q 10/04; G06F 16/901

(52) U.S. Cl. CPC G06Q 10/083; G06Q 10/04; H04L 67/12; G06F 16/9024; G06Q 10/087

(57) ABSTRACT

A network computer system communicates with a sensor platform that includes to obtain sensor information of at least a portion of a freight load. Based on the sensor information, the network computer system evaluates at least a portion of the freight load for at least one of size, shape or weight. Based on the evaluation, the network computer system determines an organizational structure for the freight load. The network computer system generates a set of instructions for loading individual items of at least the portion of the freight load in accordance with the organizational structure. The network computer system transmits data corresponding to the set of instructions to a computing device of the operator, to cause the computing device to generate a graphical guide for loading individual items at specific locations within the freight container.

### RELATED APPLICATIONS

This application claims benefit of priority to U.S. Provisional Patent Application No. 62/613,872 filed Jan. 5, 2018, titled NETWORK COMPUTER SYSTEM TO EVALUATE FREIGHT LOADS; the aforementioned application being hereby incorporated by reference in its entirety.

### BACKGROUND

Freight and shipping are integral aspects of modern society. However, freight services are often implemented for large scale operations, making it more difficult to accommodate deviations to planned freight schedules. Moreover, freight shipping is predominantly a manual process, and much inefficiency exists with respect to various facets of the field. For example, under conventional approaches the process of loading a freight vehicle can be manual and ad-hoc, resulting in the loading processing being inefficient.

### BRIEF DESCRIPTION OF THE DRAWINGS

FIG. 1 illustrates an example network computer system to determine an organizational structure for individual items of a freight load;

FIG. 2A illustrates an example method for determining an organizational structure for individual items of a freight load;

FIG. 2B illustrates an example method for generating a set of instructions to load individual items of a freight load into a freight vehicle;

FIG. 2C illustrates an example method for implementing future load planning when determining an organizational structure of a freight load;

FIG. 2D illustrates an example method for matching freight vehicles with freight service requests;

FIG. 3 illustrates an example freight load facility;

FIG. 4A illustrates an example loading UI that indicates which individual item of a freight load to load into a freight vehicle;

FIG. 4B illustrates an example loading UI indicating a particular location an individual item of a freight load is to be placed in a freight vehicle;

FIG. 4C illustrates an example loading UI indicating a loading progress of an operator and/or individual loading each individual item of a freight load into the freight vehicle;

FIG. 5A illustrates an example alternate state of an example loading UI that utilizes augmented reality to indicate which item of a freight load or a freight load is to be loaded into a freight vehicle;

FIG. 5B illustrates an example alternate state of an example loading UI that utilizes augmented reality to indicate a particular location an item is to be placed in a freight vehicle;

FIG. 6 illustrates a mobile device upon which aspects described herein may be implemented; and

FIG. 7 illustrates a computer system on which one or more example network computer systems can be implemented.

Throughout the drawings, identical reference numbers designate similar, but not necessarily identical elements. The figures are not necessarily to scale, and the size of some parts may be exaggerated to more clearly illustrate the example shown. Moreover, the drawings provide examples and/or implementations consistent with the description. However, the description is not limited to the examples and/or implementations provided in the drawings.

### DETAILED DESCRIPTION

Examples include a network computer system that evaluates freight loads for purpose of determining an organization structure or arrangement for how items of the freight load are arranged within a freight container (e.g., trailer). The organizational structure can specify the stacking and/or positioning of individual items (e.g., packages, boxes, pallets, etc.) of a freight load relative to other items of the freight load and/or other items which may already be loaded in the freight container. The network computer system may determine the organization structure for freight loads to optimize for spatial and other considerations.

In examples, a freight load includes a collection of items that are to be shipped together using a freight container. In such examples, an “item” of a freight load includes items that are individually packed for shipment (e.g., boxed by manufacturer), as well as unpacked items. In some examples, a freight container can include a predefined container that is transportable by a freight vehicle. In many examples, the freight container is described as a trailer for the freight vehicle. However, in variations, the freight container can correspond to shipping containers of predetermined sizes, suitable for carriage by a freight vehicle, or a container of a delivery van or truck.

In some examples, a network computer system can also organize a manner in which individual items of a freight load are loaded into a trailer of a freight vehicle, to accommodate, for example, a hauling route and/or anticipated load of a freight operator. Additionally, in some examples, the network computer system can optimize the loading of items in a trailer of the freight vehicle by determining an organizational structure that (i) minimizes the amount of free space in the trailer when the trailer is full, (ii) distributes a weight of the freight load within the trailer, and/or (iii) minimizes an amount or interval of time for loading or unloading of freight loads. The network computer system can optimize the loading of items based on a parameter(s) for optimization that is specified by a user or operator, a carrier (e.g., an entity that is providing the shipping service), and/or a driver of the freight vehicle.

The terms “optimal,” “optimize,” or variants thereof are intended to mean an act of achieving, through intelligent and deliberate consideration, a result or outcome that is more desired as to a particular facet or parameter. The use of such terms in reference to a given process does not necessarily mean that a result or outcome is achieved that is most optimal, but rather can mean the result or outcome is more desirable with respect to the particular facet or parameter as compared to an alternative process, or a process that is performed without deliberate consideration for the particular facet or parameter.

In some examples, the network computer system can determine an organizational structure using sensor information determined from one or more sensors provided on and/or positioned with a loading dock or platform of a shipment facility. As an addition or alternative, the network computer system can receive sensor information from sensors that are provided with a freight container (e.g., trailer) or freight vehicle. In other example, individual items of a freight load can be associated with sensor information before the items are loaded into a freight trailer. Moreover, network computer system can use sensors provided with a loading dock or trailer to remotely determine an organizational structure that optimizes for loading of individual items of a freight load. Based on an organizational structure, the network computer system can provide guidance to an operator with respect to how the freight operator loads individual items into a trailer of a freight vehicle.

As provided herein, the terms “user,” “operator” and “service provider” are used throughout this application interchangeably to describe a person utilizing an application (e.g., a provider or carrier client or web application) on a computing device to provide freight services to a freight service requester (e.g., a shipper). A freight service requester can be a person or group of people who utilize an application (e.g., a requester or shipper client or web application) on a computing device to request, over one or more networks, freight services from a network computing system.

One or more examples described herein provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

Additionally, one or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Moreover, examples described herein can generally require the use of specialized computing devices, including processing and memory resources. For example, one or more examples described may be implemented, in whole or in part, on computing devices such as servers, desktop computers, cellular or smartphones, personal digital assistants (e.g., PDAs), laptop computers, printers, digital picture frames, network equipment (e.g., routers), wearable computing devices, and tablet devices. Memory, processing, and network resources may all be used in connection with the establishment, use, or performance of any example described herein (including with the performance of any method or with the implementation of any system). For instance, a computing device coupled to a data storage device storing the computer program and configured to execute the program corresponds to a special-purpose computing device. Furthermore, any computing systems referred to in the specification may include a single processor or may be architectures employing multiple processor designs for increased computing capability.

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions. All the processing is performed by interconnected gates.

### System Description

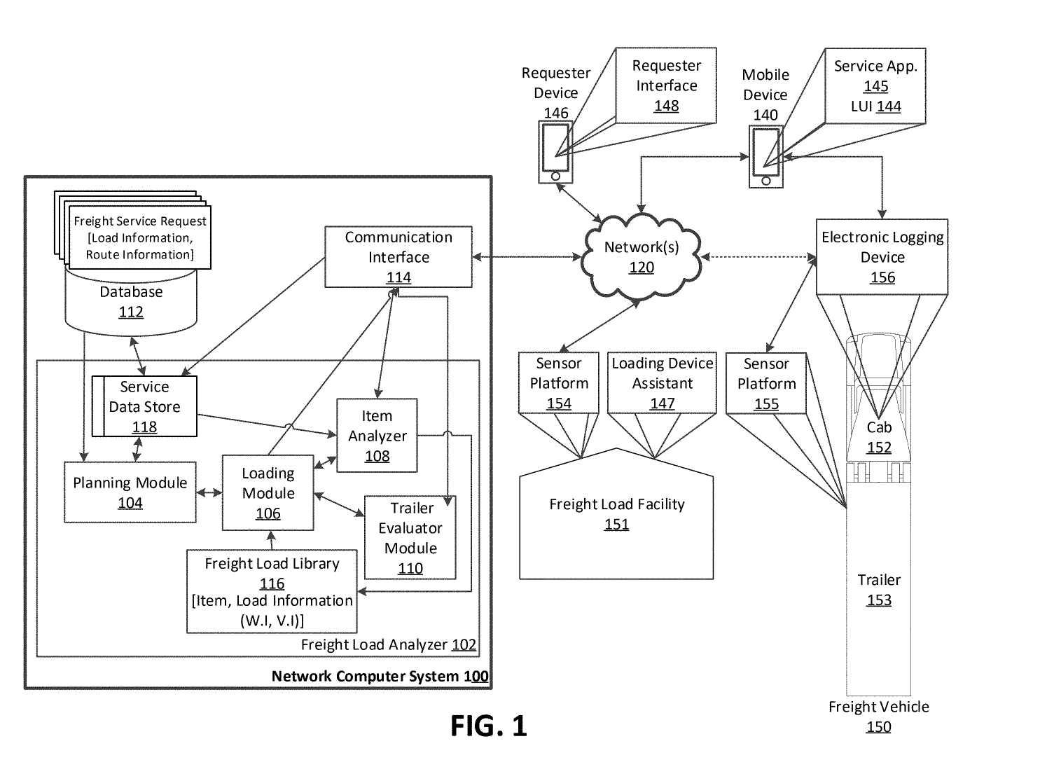

FIG. 1 illustrates an example network computer system to determine an organizational structure of a freight load in a freight container (e.g., trailer) of a freight vehicle. The organizational structure may define, for example, a position of a loaded item within a trailer of the freight vehicle and/or relative to another loaded item within the structure. As described by various examples, the organizational structure can be optimized for one or more objectives, including spatial objective such as minimizing the volume of loaded items and/or maximizing distribution of loaded items. Network computer system 100 can be implemented as part of a freight loading system that controls or otherwise influences the loading of a freight load into a trailer, in order to further such objectives. By way of example, network computer system 100 can determine (i) an order or sequence in which individual items of a freight load are loaded into a freight trailer in relation to other items of the freight load; and (ii) the position (e.g., with respect to axes of depth (X), lateral (Y) or height (Z)) of individual items relative to other items that are loaded in the freight container). In some examples, network computer system 100 can determine the organizational structure of a freight load for objectives such as (i) minimizing the amount of free space in the trailer, (ii) distributing the weight of some or all of the loaded items within the trailer, and/or (iii) minimizing an expected unloading time for a portion of the freight load at a subsequent stop.

According to some examples, network computer system 100 may be implemented by a server, combination of servers, or other network computers, either as a standalone service or as part of another service (e.g., shipping service to manage or assign freight operators). In variations, network computer system 100 may be implemented as a standalone system (e.g., as a local network service at shipping facility) or service (e.g., software-as-a service (“SAS”)).

In some implementations, network computer system 100 can include freight load analyzer 102. Freight load analyzer 102 can determine a target or desired organizational structure for individual items of a freight load that are to be loaded into trailer 153. In variations, the freight load analyzer 102 can determine the organizational structure of some or all of an existing load.

In examples, freight load analyzer 102 include planning module 104, loading module 106, item analyzer 108, trailer evaluator module 110 and freight load library 116. In such examples, loading module 106 can determine an organizational structure based on various inputs obtained from planning module 104 (e.g., item information that can be included in a freight service request), item analyzer 108 (e.g., sensor information of individual items of a freight load), trailer evaluator module 110 (e.g., sensor information of free space available in trailer 153) and freight load library 116 (e.g., stored models of said individual items).

In various implementations, network computer system 100 can instruct, plan, guide or otherwise influence the loading of individual items of a freight load, so that an interior of the loaded trailer is structured to have a particular organization that meets one or more objectives of the network computer system 100. In such implementations, before individual items of a freight load are loaded into trailer 153, network computer system 100 can determine the organizational structure in light of a volumetric capacity of trailer 153 (or the amount of free space in trailer 153 when there are no individual items in it). For example, freight load analyzer 102 can include trailer evaluator module 110 to determine the volumetric capacity of trailer 153 based on sensor information. In such example, trailer 153 can include sensor platform 155 that can generate sensor information related to trailer 153. The sensor information can indicate the amount of free space in trailer 153. In turn, trailer evaluator module 110 can determine the volumetric capacity of trailer 153 based on the sensor information obtained from sensor platform 155. In some implementations, sensor platform 155 can include one or more sensors. Examples of sensor platform 155 can include ultrasonic sensor, infrared sensor, LIDAR, radar, temperature and/or a weight sensor.

In some implementations, network computer system 100 (e.g., loading module 106) can obtain sensor information generated by sensor platform 155 from mobile device 140 of the freight operator. For example, network computer system 100 can directly and wirelessly (e.g., WIFI, BLUETOOTH, BLE (BLUETOOTH low energy), NFC, or other appropriate short-range communication) obtain such sensor information from mobile device 140. In such implementations, mobile device 140 obtains such sensor information from electronic logging device (ELD) 156. In other implementations, components of network computer system 100 (e.g., loading module 106) can obtain sensor information generated by sensor platform 155 directly from ELD 156. For example, network computer system 100 can directly and wirelessly (e.g., WIFI, BLUETOOTH, BLE (BLUETOOTH low energy), NFC, or other appropriate short-range communication) obtain such sensor information from ELD 156.

In light of an amount of free space in trailer 153, network computer system 100 can determine an organizational structure of individual items of a freight load based on sensor information (e.g., shape, surface, size, position, orientation, volumetric and/or weight information) of the individual items. In some implementations, the sensor information can be generated by sensor platform 154 included in freight load facility 151. In such implementations, freight load analyzer 102 can obtain the sensor information generated by sensor platform 154 via communication interface 114 and over network 120. Sensor platform 154 can include one or more sensors. Examples of sensor platform 154 can include cameras, ultrasonic sensor, infrared sensor, LIDAR, radar, temperature sensor and/or a weight sensor. Sensors that can decipher information about the shape and size of individual items may, for example, be arranged to circumvent a loading platform on which a shipper initially places a load. As an addition or variation, freight load facility 151 can include sensor platform 154 that is above a loading dock with individual items of a freight load. In such an implementation, sensor platform 154 can generate sensor information of each individual item of the freight load that is within the sensory range of each sensor included in sensor platform 154. Additionally, the sensor information can indicate up to 360 or up to 180 degrees perspectives of individual items in the freight load on the loading dock.

Freight load analyzer 102 can include item analyzer 108 to determine from sensor information of each individual item of a freight load, volumetric information and/or weight information of each individual item. In such implementations, the weight information and/or volumetric information can be associated with the corresponding identifier of the individual item. For example, sensor platform 154 can include a set of LIDAR sensors, cameras, radar and/or ultrasonic sensors which are arranged to substantially circumvent a load. The sensors can individually generate sensor information that includes depth information (e.g., distance from field of sensor view to surface of object) and surface information for determining, for example, shape, contour and/or size. Based on the sensor information of that individual item, item analyzer 108 to can determine shape, surface, size, position, orientation and/or volumetric information for individual items of a load.

In various implementations, item analyzer 108 can determine shape, surface, size, position, orientation and/or volumetric information for an individual item of a freight load based on fiducials and/or sensor perceptible markers, which may exist with the individual items, load, or sensor platform. In some examples, individual items can be associated with a marker or fiducial (e.g., corner of a packaging of an individual item) that when detected, facilitates the determination of physical characteristics such as shape, surface, size and/or volumetric information. In other implementations, sensor platform 154 can include a weight sensor to determine weight information associated with the individual item. As an addition or variation, the trailer of the freight vehicle may include the weight sensor.

Loading module 106 can utilize volumetric information and/or weight information to determine an organizational structure for loading each individual item of a freight load into trailer 153 of freight vehicle 150. In some examples, based on the volumetric information and/or weight information of a freight load, loading module 106 can determine a sequence of stacking-order to load each individual item of the freight load. In other examples, based on volumetric information and/or weight information of a freight load, loading module 106 can determine a location and/or a positioning/orientation for each individual item of the freight load. Additionally, or alternatively, based on the weight information, loading module 106 can determine a location and/or positioning/orientation for each individual item of the freight load to distribute a weight of each individual item to be loaded into the trailer. Moreover, loading module 106 can determine the organizational structure in light of the free space information determined by trailer evaluator module 110.

In some implementations, trailer 153 can have a weight restraint. As such, loading module 106 can determine whether each individual item in the freight load abides by the weight restraint of trailer 153, based on the weight information of each individual item. In implementations where multiple freight service requests are assigned to an operator of freight vehicle 150, loading module 106 can determine whether the weight information of the multiple freight service requests abide by the weight restraint. In such implementations, loading module 106 can notify the operator when the freight loads and/or one or more individual items of the multiple freight service requests do not abide by the weight restraint of trailer 153.

In some implementations, loading module 106 can determine an organizational structure in the context of an on-demand freight service. In such implementations, network computer system 100 can manage the on-demand freight service by assigning a freight service request from a requester (e.g., shipper) to an available freight operator (e.g., an operator of freight vehicle 150). The freight service request can include item information. Additionally, the item information can identify load items, with each load item referencing a container that may have a dimension and/or other known characteristics (e.g., weight, shape). As an addition or variation, the item information may identify irregular items, or items which are ‘unknown’ in size, weight or shape. Additionally, the item information associated with the individual items can include volumetric information. Accordingly, loading module 106 can determine the organizational structure based on the item information included in the freight service request assigned to the available operator (e.g., the operator of freight vehicle 150).

In various implementations, network computer system 100 can obtain a freight service request from a requester (e.g., shipper) via requester interface 148 (e.g., portal for shipper, device operated by shipper). For example, the requester can provide a freight service request via requester interface 148 running on requester device 146. In such implementations, the freight service request can be obtained by service data store 118 and stored in database 112.

In some implementations, network computer system 100 can verify item information of each individual item included in a freight service request. For example, an operator of freight vehicle 150 can be assigned to a freight service request. Prior to picking up a freight load specified in the freight service request, sensor platform 154 at freight load facility 151 can generate sensor information for each individual item of the freight load specified in the freight service request. Item analyzer 108 can obtain the sensor information from sensor platform 154 and determine volumetric and weight information of each individual item of the freight load. Additionally, item analyzer 108 can compare volumetric and weight information of each individual item to volumetric and weight information included in item information provided with the freight service request. In some examples, item analyzer 108 can obtain the freight service request assigned to the operator of freight vehicle 150 and any information associated with the freight service request from service data store 118.

In other implementations, network computer system 100 can utilize item information of a freight service request to determine an organizational structure for some individual items and sensor information for other individual items. For example, loading module 106 can determine an organizational structure for individual items that are (i) cuboidal in shape (e.g., a container of bicycles) based on the item information of the freight service request; and/or (ii) non-cuboidal in shape (e.g., a canoe) based on the sensor information (e.g., weight and/or volumetric information) obtained from sensor platform 154.

In yet other implementations, item information of a freight service request can include a determination of fragility (or other non-standard shipping and handling classification (e.g., hazardous material) for individual items of the freight load. In such implementations, an organizational structure to load the individual items can be based on whether the individual items have received non-standard shipping and handling classification. In variations, item analyzer 108 can infer a non-standard shipping and handling instruction based on the items in the load that is subject to the freight service request, based on information known about items of the class (e.g., as stored in freight load library 116). As such, based on which individual items have been designated as fragile (or other non-standard shipping and handling classification), loading module 106 can determine an organizational structure that ensures the individual items that have been determined as fragile are safely positioned in trailer 153. For example, the individual items that have been determined as fragile can be placed on top of individual times that are not designated as fragile (or other non-standard shipping and handling classification).

According to some implementations, as illustrated in FIG. 1, network computer system 100 can generate and store models of each individual item. For example, as illustrated in FIG. 1, network computer system can include freight load library 116. In some examples, freight load library 116 can generate models of each individual item of a freight load specified in a freight service request based on the item information (e.g., weight information, volumetric information, etc.) included in the freight service request. Additionally, each model of each individual item can be updated for accuracy. For example, sensor platform 154 can provide sensor information of the corresponding individual item. In such examples, freight load library 116 may store a model for the corresponding individual item. Item analyzer 108 can then provide the updated volumetric information to freight load library 116 so that freight load library 116 can update the stored corresponding model with the volumetric information of the corresponding individual item. Moreover, in such implementations, loading module 106 can utilize the models of each individual item to determine an organizational structure.

In other implementations, a model of an individual item may be initially based on sensor information from sensor platform 154 (e.g., an individual item that is non-cuboidal in shape). In such implementations, sensor platform 154 may detect the same type of individual item again and generate sensor information corresponding to that individual item. As such, freight load library 116 can utilize the sensor information of the individual item to update the corresponding model of that individual item. Additionally, loading module 106 can utilize a model of such an individual item to determine an organizational structure including the individual item.

In various implementations, network computer system 100 can cause item loading device assistant 147 to generate a graphical guide on service application 145 for an individual that loads items of a load onto the trailer 153. In some examples, item loading device assistant 147 can be implemented by service application 145 running on mobile device 140 (e.g., smartphones, tablet computers, virtual reality or augmented reality handsets, on-board computing systems of vehicles, etc.). In variations, item loading device assistant 157 can be implemented as a specialized device that is available at the dock. In such implementations and variations, item loading device assistant 157 can provide a graphical user interface and feedback with respect to how the items of the load can be loaded in accordance with the organizational structure determined by loading module 106. The graphical guide can consist of various loading user interfaces (UIs) that can assist an operator of freight vehicle 150 or an individual loading individual items of a freight load into trailer 153 of freight vehicle 150. For example, based on the organizational structure to optimize loading of each individual item in trailer 153 of freight vehicle 150, loading module 106 can generate an instruction or a set of instructions to provide to mobile device 140. Based on the instruction, mobile device 140 can then cause service application 145 to generate and present a loading UI on a display of mobile device 140. Additionally, based on the instruction, mobile device 140 can also generate a loading UI. The loading UI can indicate how to load each individual item of the freight load into trailer 153. In some examples, based on the instruction, mobile device 140 can generate a graphical representation of each individual item, a graphical guide indicating an order to load each individual item, a graphical representation of a location in trailer 153 each individual item is to be placed, a graphical guide of how each individual item is to be oriented or positioned in trailer 153, and/or a graphical guide of the stacking order of each individual item.

As an addition or variation, planning module 104 can determine, from multiple freight service requests stored in database 112, an additional freight service request that specifies a freight load and/or individual items of a freight load that can fit into the amount of free space still available in trailer 153. In some implementations, loading module 106 can determine an amount of free space still available in trailer 153 in light of a determined organizational structure for individual items of a freight load. For example, loading module 106 can determine the amount of free space still available in trailer 153 based on (i) the volumetric capacity determined by trailer evaluator module 110 and (ii) the determined organizational structure. As such, planning module 104 can determine an additional freight service request that specified individual items that can fit into said free space. For example, such a determination can be based on the volumetric and/or weight information associated with the additional freight service request. In some implementations, the weight and/or volumetric information can be obtained from item information corresponding to each of the multiple freight service requests stored in database 112. In other implementations, the weight and/or volumetric information can be obtained from sensor information associated with each individual item of one or more freight loads specified in each of the multiple freight service requests stored in database 112. In such implementations, the sensor information can be generated by sensor platform 154 and associated with a corresponding freight load identifier of each individual item. Additionally, planning module 104 can obtain such weight and/or volumetric information from database 112. In turn, loading module 106 can add the individual items of the additional freight service request to the determined organizational structure, based on the volumetric and/or weight information associated with the individual items of the additional freight service request. Additionally, loading module 106 can cause mobile device 140 to generate a graphical guide that includes the individual items of the additional freight service request.

In some implementations, while an operator or individual is loading each individual item of a freight load into trailer 153, network computer system 100 can provide loading feedback to the operator or individual. For example, loading module 106 can determine whether the individual items have been loaded into trailer 153 according to the determined organizational structure, based on determinations made by trailer evaluator module 110. In such an example, trailer evaluator module 110 can obtain sensor information generated by sensor platform 155. Based on the sensor information generated by sensor platform 155, trailer evaluator module 110 can determine weight, size, position, orientation, and/or volumetric information of individual items loaded into trailer 153. In turn, loading module 106 can determine whether the operator or individual has loaded each individual item according to the organizational structure determined by loading module 106. For instance, loading module 106 can compare the current position information of each individual item loaded into trailer 153 to the determined organizational structure. Based on the positioning of each individual item loaded into the trailer, loading module 106 can determine whether the individual item was loaded into trailer 153 in the right order, stacking order/position, location inside trailer 153, and/or orientation or position, according to the determined organizational structure.

In some implementations, individual items loaded into trailer 153 can be associated with markers or fiducials (e.g., on the surface of each individual item). In such implementations, the sensor information generated by sensor platform 155 can include fiducial information of the individual items loaded into trailer 153. Such fiducial information can include information that identifies (i) the loaded item within trailer 153 and (ii) the orientation of the item within trailer 153 relative to other items within trailer 153. In some examples, trailer 153 may include fiducials and as such the fiducial information may also indicate the location of each fiducial on trailer 153, to provide a reference frame with respect to depth and/or orientation of individual items within trailer 153. As such, trailer evaluator module 110 can determine volumetric and positional information of each individual item with a fiducial that has been loaded in trailer 153, based on the fiducial information. In turn, loading module 106 can determine whether the operator or individual has loaded each individual item according to the determined organizational structure. For example, loading module 106 can compare the current position information of each individual item loaded into trailer 153 to the determined organizational structure. Additionally, based on the positioning of each individual item loaded into the trailer, loading module 106 can determine whether the individual item was loaded into trailer 153 in the right order, stacking order/position, location inside trailer 153, and/or orientation or position, according to the determined organizational structure. If loading module 106 determines that the individual item was loaded incorrectly, as according to the determined organizational structure, loading module 106 can provide feedback instructions to mobile device 140 to assist the operator or individual to correct that mistake. For example, the feedback instructions can cause service application 145 to generate graphical representations indicating how to correct a loading error.

Accordingly, in some implementations, after each individual item of a freight load specified in a freight service request has been loaded, there can still be an amount of free space in trailer 153. In such implementations, loading module 106 can determine additional items of an additional freight service request that can be added to trailer 153 in light of the amount of free space still available in trailer 153. For example, trailer evaluator module 110 can determine the amount of free space still available in trailer 153, based on sensor information generated by sensor platform 155. Additionally, based on the determined amount of free space still available in trailer 153, loading module 106 can cause planning module 104 to determine an additional freight service request with individual items that can fit in said free space. For example, such a determination can be based on the volumetric and/or weight information associated with the additional freight service request. In some implementations, the weight and/or volumetric information can be obtained from item information corresponding to each of the multiple freight service requests stored in database 112. In other implementations, the weight and/or volumetric information can be obtained from sensor information associated with each individual item of one or more freight loads specified in each of the multiple freight service requests stored in database 112. In such implementations, the sensor information can be generated by sensor platform 154 and associated with a corresponding freight load identifier of each individual item. Additionally, planning module 104 can obtain such weight and/or volumetric information from database 112. In turn, loading module 106 can add the individual items of the additional freight service request to the determined organizational structure, based on the volumetric and/or weight information associated with the individual items of the additional freight service request. Additionally, loading module 106 can cause mobile device 140 to generate a graphical guide that includes the individual items of the additional freight service request.

In various implementations, freight load analyzer 102 can include planning module 104 to determine a hauling route for a freight operator based on a freight service request assigned to the freight operator. In such implementations, a freight service request can include routing information. The routing information can include one or more service locations, the preferred time or window of time to pick up the load at the pick-up location, and/or the preferred time or window of time of freight service completion (e.g., the preferred time to drop-off the load at the destination location). A service location of the routing information can include the pick-up location (e.g., a warehouse where the load is being housed) and the destination location (e.g., the location where the load is to be dropped off). In some implementations, planning module 104 can determine a hauling route for operator to take based on the routing information. As such, a hauling route can be determined for an operator assigned to a freight service request, based on the routing information of the assigned freight service request.

In some implementations, planning module 104 can take into account toll locations, traffic data and/or traffic data when determining a hauling route. In such implementations, location information for each toll in one or more geographic regions, weather data and/or traffic data can be obtained from a third-party provider. In other implementations, weather data and/or traffic data can be obtained from one or more sensors of freight vehicle 150 and other freight vehicles traveling in and around the same region or hauling route as freight vehicle 150.

In various implementations, freight load analyzer 102 can include a service data store 118 that maintains a record (or set of records) for freight service requests that are assigned to individual operators or freight operators. Each record stored in service data store 118 can be periodically or continuously updated. In some examples, each record can include a freight service request a freight operator is currently assigned to. In some examples, service data store 118 can update item information each individual item of a freight load specified in a freight request assigned to a freight operator. For instance, service data store 118 can update volumetric information for an individual item that was determined from sensor information generated by sensor platform 154. The updated volumetric information can be obtained from item analyzer 108.

In other examples, service data store 118 and database 112 can obtain identifiers of each individual item of a freight load. The identifiers can be specific to each individual item and include an identifier that is specific to the freight load the individual items are included with. For example, each individual item can have sensor detectable freight load identifiers or fiducials. Additionally, a sensor from a sensor platform (e.g., sensor platform 154 or sensor platform 155) can detect and generate sensor information that includes the sensor detectable load identifiers or fiducials. In turn, service data store 118 or database 112 can obtain the sensor load identifiers or fiducials from the sensor information generated by the sensor. Based on the identifier of the freight load, database 112 and/or service data store 118 can add the identifiers of each individual item of the freight load to the record of the corresponding freight load stored in database 112 and/or service data store 118, respectively. In such implementations, loading module 106, planning module 104 and item analyzer 108 can update each record and obtain information from each record stored in service data store 118 or database 112. In some implementations, service data store 118 and database 112 can be separate databases. In other implementations, service data store 118 and database 112 can be included in the same database.

In some implementations, while a freight operator is on a hauling route fulfilling a first freight service request, planning module 104 can make detours to pick-up additional freight loads of freight service requests subsequently assigned to a freight operator. For example, while the operator is currently fulfilling a first freight service request, trailer evaluator module 110 can determine free space information of trailer 153. Additionally, loading module 106 can determine an amount of free space in trailer 153 based on the free space information of trailer 153. Based on the amount of free space, planning module 104 can determine a subsequent freight service request that specifies a freight load and/or the corresponding individual items that can fit into the amount of free space still available in trailer 153. Planning module 104 can determine the subsequent freight service request from the multiple freight service requests stored in database 112. In some examples, item analyzer 108 can determine volumetric information of each individual item specified in the multiple freight service requests stored in database 112, based on item information included in the other freight service requests. In other examples, item analyzer 108 can determine volumetric information from sensor information generated by sensor platform 154 that is associated with each individual item specified in the multiple freight service requests stored in database 112. Based on the volumetric information of each individual item in other freight service requests, loading module 106 can identify a freight service request (e.g., the second freight service request) that specifies one or more individual items or a freight load that would fit into the determined amount of free space in trailer 153.

Additionally, planning module 104 can take into account any weight restraints trailer 153 may have, when determining a subsequent freight load to add to a current freight load being transported by freight vehicle 150. For example, in addition to volumetric information of each individual item, planning module 104 can also take into account weight information of each individual items of specified in other freight service requests. In such an example, item analyzer 108 can provide to planning module 104 weight information of one or more individual items of multiple freight service requests stored in database 112. As such, based on such weight information, planning module 104 can identify a subsequent freight service request from the multiple freight service requests stored in database 112 that specifies one or more individual items that can (i) fit in a determined amount of free space in trailer 153 and (ii) abides by the weight constraints of trailer 153. In some implementations, item analyzer 108 can obtain weight information of each individual item of each of the multiple freight service requests from item information included in each of the multiple freight service requests. In other implementations, item analyzer 108 can obtain weight information of each individual item of each of the multiple freight service requests from sensor information. The sensor information can be generated by sensor platform 154.

Moreover, while a freight operator is on a hauling route fulfilling a first freight service request, loading module 106 can determine and use information about a freight operator's subsequently assigned freight service request to determine (i) whether to reorganize the organizational structure of a current freight load to accommodate the freight load of the subsequently assigned freight service request or (ii) the organizational structure for individual items of a freight load specified in the subsequent freight service request in light of the organizational structure of the current freight load. Additionally, in such implementations, loading module 106 can take into account the item information (e.g., the volumetric information and/or weight information) and/or sensor information included with the freight service request, when making such determinations. In some implementations, prior to the freight operator being on the hauling route (e.g., the freight operator is currently at freight load facility 151), loading module 106 can determine an additional freight load of an additional freight service request to add to a freight load currently loaded in trailer 153. In such implementations, loading module 106 can determine (i) whether to reorganize the organizational structure of the freight load currently loaded in trailer 153 to accommodate the freight load of the subsequently assigned freight service request or (ii) the organizational structure for individual items of a freight load specified in the additional freight service request in light of the organizational structure of the freight load currently loaded in trailer 153.

Planning module 104 can take into account one or more service locations specified in other freight service requests when identifying one or more additional individual items for the operator to transport. For example, planning module 104 can identify a freight service request from multiple freight service requests stored in database 112 that includes a service location (e.g., pick-up location and/or destination location) within a proximity distance threshold from a current location of the operator or freight vehicle 150. Planning module 104 can determine the current location of the operator or freight vehicle 150, based on location information provided by a location-based resource of mobile device 140. In some examples, planning module 104 can identify a freight service request from the multiple freight service requests stored in database 112 that includes a service location (e.g., pick-up location and/or destination location) within a proximity distance threshold from a hauling route the operator or freight vehicle 150 is currently utilizing.

Additionally, or alternatively, planning module 104 can take into account the preferred time or window of time of freight service completion of a freight service request the operator is currently fulfilling, when identifying one or more additional individual items the operator can transport. For example, planning module 104 can identify a freight service request from multiple freight service requests stored in database 112 that if fulfilled by the operator would not cause the operator to delay completion of the first freight service request. The identified freight service request can specify one or more individual items of a freight load to transport. In some examples, a delay occurs if the operator completes a freight service request after the preferred time or window of time of freight service completion of the freight service request. In other examples, a delay occurs if the operator completes a freight service request beyond a predetermined amount of time after the preferred time or window of time of freight service completion of the freight service request.

Based on routing information of a freight service request identified by planning module 104, planning module 104 can determine a detour route from the hauling route an operator and/or freight vehicle 150 is utilizing. In some implementations, planning module 104 can determine a detour route that can minimize or eliminate any potential delay to the completion of the first service request. In some examples, planning module 104 can take into account the preferred time or window of time of freight service completion of a first freight service request the operator is currently fulfilling, when determining a detour route. For example, planning module 104 can determine a detour route from the hauling route that can minimize a potential delay to the service completion time of the first service request beyond the preferred time or window of time of freight service completion of the freight service request. In other examples, planning module 104 can determine a detour route from the hauling route that can minimize a potential delay to the service completion time of the first service request beyond a predetermined amount of time after the preferred time or window of time of freight service completion of the freight service request. As such, planning module 104 can provide detour routing instructions to mobile device 140.

In implementations where a freight operator is on a hauling route and currently fulfilling a freight service request, loading module 106 can determine an organizational structure to optimize loading of each individual item of an additional freight load of a subsequently assigned freight service request an operator is to pick-up. In such implementations, loading module 106 can optimize the loading of each individual item in the trailer of the freight vehicle by determining an organizational structure that can (i) minimize the amount of free space in the trailer, (ii) distribute a weight of each individual item to be loaded into the trailer, and/or (iii) minimize an amount or interval of time for loading or unloading of each individual item.

In variations, the organizational structure for the freight load can be based on a preferred service completion time. For example, the operator can be assigned to a first service request that specifies transporting a first freight load, including multiple items, to Portland, Oreg. on October 15. Additionally, the operator can also be assigned to a second service request that specifies transporting a second freight load, including multiple items, to San Francisco, Calif. on October 13. Based on the service completion times (October 15 and October 13) and the service locations (Portland, Oreg. and San Francisco, Calif.), loading module 106 can determine that the items of the first service request should be loaded into trailer 153 before the items of the second service request. In some implementations, loading module 106 can provide instructions to mobile device 140. As such, based on the instructions, mobile device 140 can cause service application 145 to generate a graphical guide indicating how to load trailer 153, based on such determinations.

In another example, an operator can be assigned to a first service request that specifies transporting a first freight load, including multiple items, to San Francisco, Calif. on October 13. While heading to San Francisco, the operator is assigned to a second service request that specifies transporting a second freight load, including multiple items, to Portland, Oreg. on October 15. Based on the service completion times (October 13 and October 15) and the service locations (San Francisco, Calif. and Portland, Oreg.), loading module 106 can determine that the operator may have to reorganize trailer 153 so that the items of the second service request should be loaded into the back of trailer 153 while the items of the first service request should be nearest to the door of trailer 153. In some implementations, loading module 106 can provide instructions to mobile device 140. As such, based on the instructions, mobile device 140 can cause service application 145 to generate a graphical guide that indicates how to load trailer 153, based on such determinations.

With further reference to an example of FIG. 1, network computer system 100 can cause mobile device 140 to generate a graphical guide on service application 145 running on mobile device 140. Additionally, network computer system 100 can cause mobile device 140 to generate and present the graphical guide as various loading user interfaces (alternatively referred to as “loading UIs 144”). In some examples, a server or other component of network computer system 100 can communicate information, content and other data to enable mobile device 140 (e.g., using service application 145) to generate loading UI 144, where loading UI 144 includes content that is specific to the particular freight load and/or physical site. In such examples, the server(s) of network computer system 100 can receive a sensor view of items of a freight load, or alternatively, a sensor view of an interior of the trailer of the freight vehicle. In variations, the sensor platform can communicate at least some aspects of the sensor view directly to mobile device 140 of the operator.

In examples, loading UI 144 is implemented using dynamic content, such as provided by animation, video, and/or virtual content (e.g., augmented reality). In some implementations, the loading UO can depict a virtual representation of individual items of the freight load, as well as the interior of the trailer and/or the shipping facility where the items of the freight load are collected for freight transport. In variation, loading UI 144 can include an augmented reality rendering, such as one created by depicting a live video feed of the shipment facility and/or trailer, overlaid by one or more virtual layers representing the items of the freight load, the interior of the freight container, and/or the shipping facility. The virtualized representations can be dynamic, to reflect a current state of the individual items of the freight load, as well as of the interior of the trailer or freight container.

In examples, loading UI 144 can be used to communicate instructions to the operator, where the instructions are provided in the form of graphical content (e.g., arrows, markers, coloring variations) or other output. Loading UI 144 can specify instructions for actions the operator can perform, in connection with a task, or a series of tasks which collectively cause individual items of a freight load to be moved from the shipping facility to a target location within the trailer. The instructions of loading UI 144 can, for example, specify one or more of (i) locations within the shipping facility where individual items of the freight load are located, (ii) a path or direction to the location of individual items, and/or (iii) a target location within the trailer or freight container of the freight vehicle. As an addition or variation, the instructions can specify an orientation or configuration for individual items when placed within the trailer of the freight vehicle. As another addition or variation, the instructions communicated through loading UI 144 can also communicate specific tasks, or series of tasks, such as instructions which identify an action that the operator is to perform, corresponding to dropping items from a storage shelf to ground, sliding or pushing the item (or lifting the item) to the trailer of the vehicle, and lifting (and/or turning) the freight shipment at a desired location within the trailer of the freight vehicle.

Mobile device 140 can present loading UI 144 on a display of mobile device 140. In some implementations, loading UI 144 can be configured based on the organizational structure and/or tasks determined by network computer system 100.

Network 120 can include one or more networks. Network 120 can be a conventional type, wired or wireless, and can have numerous configurations include a star a star configuration, token ring configuration, or other configurations. Furthermore, network 120 can include an intranet, a local area network (LAN), a wide area network (WAN) (e.g., the Internet), and/or other interconnected data paths across which multiple devices can communicate. In some embodiments, network 120 can be a peer-to-peer network. Network 120 can also be coupled with or include portions of a telecommunications network for sending data using a variety of different communication protocols. In some embodiments, network 120 can include BLUETOOTH (or BLUETOOTH low energy) communication networks or a cellular communications network for sending and receiving data including via short messaging service (SMS), multimedia messaging service (MMS), hypertext transfer protocol (HTTP), direct data connection, WAP, email, etc. Although FIG. 1 illustrates one network 120, network 120 can be more than one network. For example, as illustrated in FIG. 1, network computer system 100 and mobile device 140, can communicate over network 120 using wired or wireless connections, or combinations thereof.

### Methodology

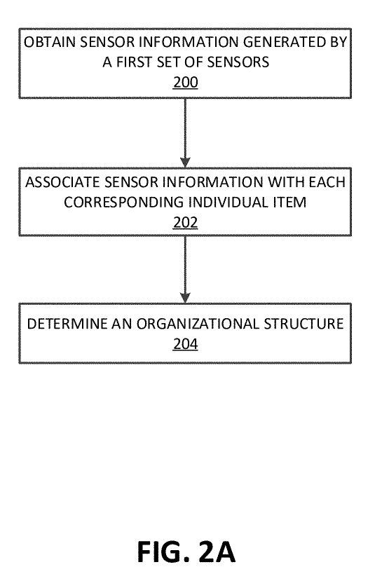

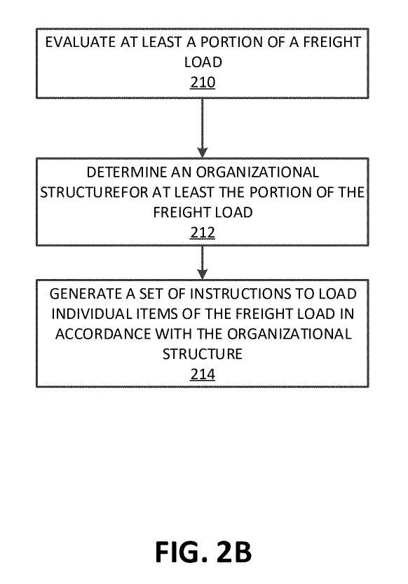

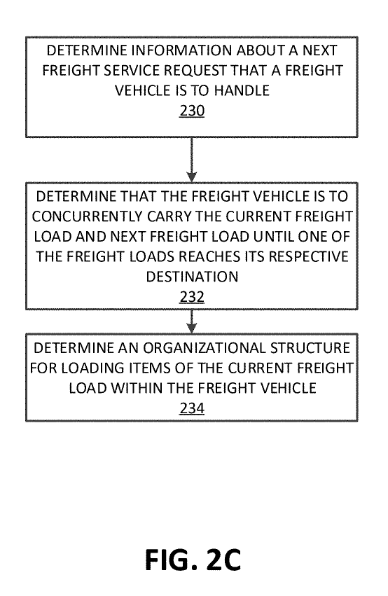

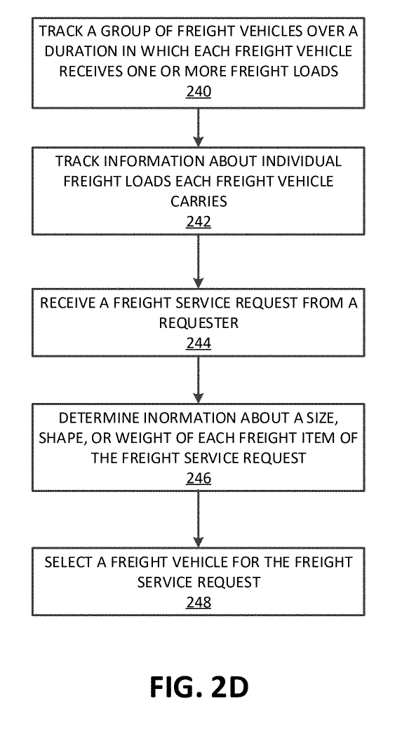

FIG. 2A illustrates an example method for determining an order for loading items into a freight vehicle. FIG. 2B illustrates an example method for generating a set of instructions to load individual items of a freight load into a freight vehicle. FIG. 2C illustrates an example method for implementing future load planning when determining an organizational structure of a freight load. FIG. 2D illustrates an example method for matching freight vehicles with freight service requests. In the below discussions of FIG. 2A-2D, reference may be made to reference characters representing like features as shown and described with respect to FIG. 1 for purpose of illustrating a suitable component for performing a set or sub-step being described.

FIG. 2A illustrates an example method for evaluating a freight operator. In some implementations, as illustrated in FIG. 2A, network computer system 100 obtains sensor information generated by a first set of sensors (200). In such implementations, the sensor information can be generated by sensor platform 154 included in freight load facility 151. Additionally, loading module 106 can obtain the sensor information generated by sensor platform 154 via communication interface 114 and over network 120. Moreover, sensor platform 154 can include one or more sensors. Examples of sensors sensor platform 154 can include ultrasonic sensor, infrared sensor, LIDAR, radar and/or a weight sensor. In some implementations, freight load facility 151 can include a loading dock sensor platform that includes sensor platform 154. Additionally, the sensor platform 154 can generate sensor information of each individual item of the freight load that is within the sensory range of sensor platform 154.

Network computer system can associate the sensor information with each corresponding individual item (202). In some implementations, each individual item of a freight load can include a freight load identifier, for example a sensor detectable freight load identifier or a fiducial. Each identifier of each individual item can be stored in database 112. Additionally, sensor information of each individual item can be associated with each corresponding identifier of each individual item that is stored in database 112.

In some implementations, item analyzer 108 can determine from the sensor information of each individual item of a freight load, volumetric information and/or weight information of each individual item. In such implementations, the weight information and/or volumetric information can be associated with the corresponding identifier of the individual item. For example, sensor platform 154 can include an ultrasonic sensor. The ultrasonic sensor can detect and generate sensor information that includes one or more distances of one or more surfaces of an individual item of the freight load. Based on the sensor information of that individual item, item analyzer 108 to can determine volumetric information associated with that individual item. For instance, item analyzer 108, based on the volumetric information, can determine a shape and/or one or more volumetric attributes of that individual item. Such volumetric information can be associated with the corresponding identifier of that individual item in database 112.

Additionally, or alternatively, item analyzer 108 can determine volumetric information of an individual item of a freight load based on one or more fiducials or sensor detectible freight load identifiers associated with the individual item. In such examples, each individual item can have the one or more fiducials on the surface of each individual item, for example, on each corner of a packaging of an individual item. Additionally, sensor information of that individual item, generated by sensor platform 154, can include fiducial information. In turn, item analyzer 108 can utilize the fiducial information to determine the shape and volumetric attributes of that individual item. For example, the fiducial information can indicate that a fiducial is placed on each corner of a packaging of an individual item. Based on the fiducial information, item analyzer 108 can determine the positioning and orientation of each fiducial relative to the other fiducials to determine volumetric information associated with the individual item.

In other implementations, sensor platform 154 can include a weight sensor. The weight sensor can detect and generate sensor information of the individual item. For instance, item analyzer 108 can determine weight information associated with the individual item (e.g., the weight of the individual item) based on the sensor information generated by the weight sensor.

Network computer system can determine an organizational structure (204). The organizational structure can include the order that each individual item of a freight load is loaded into or out of the trailer of the freight vehicle relative to other individual items already loaded in the trailer. Additionally, the organizational structure can include the stacking and/or positioning of each individual item of a freight load relative to other individual items of the freight load to be loaded or that is already loaded in the trailer. In some implementations, loading module 106 can optimize the loading of each individual item in the trailer of the freight vehicle by determining an organizational structure that can (i) minimize the amount of free space in the trailer, (ii) distribute a weight of each individual item to be loaded into the trailer, and/or (iii) minimize an amount or interval of time for loading or unloading of each individual item. Additionally, based on the sensor information associated with each individual item of a freight load, loading module 106 can determine an organizational structure for loading individual items of a freight load into trailer 153 of freight vehicle 150.

In some implementations, loading module 106 can utilize volumetric information and/or weight information to determine an organizational structure for loading each individual item of a freight load into trailer 153 of freight vehicle 150. In some examples, based on the volumetric information and/or weight information of a freight load, loading module 106 can determine an order/stacking-order to load each individual item of the freight load. In other examples, based on volumetric information and/or weight information of a freight load, loading module 106 can determine a location and/or a positioning/orientation for each individual item of the freight load. Additionally, or alternatively, based on the weight information, loading module 106 can determine a location and/or positioning/orientation for each individual item of the freight load to distribute a weight of each individual item to be loaded into the trailer. In other implementations, loading module 106 can take into account any weight restraints of trailer 153 can have.

In other implementations, network computer system 100 can utilize item information of a freight service request to determine an organizational structure for some individual items and sensor information for other individual items. In some examples, loading module 106 can determine an organizational structure for individual items that are cuboidal in shape (e.g., a container of bicycles) based on the item information of the freight service request. Additionally, loading module 106 can determine the organizational structure for individual items that are non-cuboidal in shape (e.g., a canoe) based on the sensor information (e.g., weight and/or volumetric information) obtained from sensor platform 154.

In various implementations, network computer system 100 can cause mobile device 140 (e.g., smartphones, tablet computers, virtual reality or augmented reality handsets, on-board computing systems of vehicles, etc.) to provide a graphical guide. The graphical guide can include various loading user interfaces (UIs) that can assist an operator of freight vehicle 150 or an individual loading individual items of a freight load into trailer 153 of freight vehicle 150. For example, based on the organizational structure to optimize loading of each individual item in trailer 153 of freight vehicle 150, loading module 106 can provide an instruction to mobile device 140. Based on the instruction, mobile device 140 can generate a graphical guide of how to load each individual item of the freight load into trailer 153. In some examples, based on the instruction, mobile device 140 can generate a graphical representation of each individual item, a graphical guide of an order to load each individual item, a graphical representation of a location in trailer 153 each individual item is to be placed, a graphical guide of how each individual item is to be oriented or positioned in trailer 153, and/or a graphical representation of the stacking order of each individual item.

FIG. 2B illustrates an example method for generating a set of instructions to load individual items of a freight load into a freight vehicle. In some implementations, network computer system 100 can evaluate at least a portion of a freight load for at least one of size, shape or weight (210). Additionally, network computer system 100 can evaluate the portion of the freight load by communicating with sensor platform 154 that has measured one or more portions of the freight load. Sensor platform 154 can measure portions of the freight load that is within the sensory range of sensor platform 154. Additionally, sensor platform 154 can generate and communicate to network computer system 100 sensor information that network computer system 100 can utilize to evaluate the size, shape and/or weight of the portions of the freight load that is measured by sensor platform 154.

Network computer system 100 can determine an organizational structure for at least the portion of the freight load within trailer 153 of freight vehicle 150, based on evaluating at least the portion of the freight load (212). In some implementations, network computer system 100 can determine from the sensor information, volumetric information and/or weight information of portions of the freight load that is within the sensory range of sensor platform 154. Additionally, based on the volumetric information and/or weight information, network computer system 100 can determine an organizational structure. The organizational structure can include the order that each individual item of a freight load is loaded into or out of trailer 153 of freight vehicle 150 relative to other individual items already loaded in trailer 153. Additionally, the organizational structure can include the stacking and/or positioning of each individual item of a freight load relative to other individual items of the freight load to be loaded or that is already loaded in trailer 153. In some implementations, network computer system 100 can optimize the loading of each individual item in trailer 153 of freight vehicle 150 by determining an organizational structure that can (i) minimize the amount of free space in the trailer, (ii) distribute a weight of each individual item to be loaded into the trailer, and/or (iii) minimize an amount or interval of time for loading or unloading of each individual item.

Additionally, based on the organizational structure, network computer system 100 can generate a set of instructions to load individual items of the freight load into trailer 153 of freight vehicle 150 (214). In some examples, network computer system can cause a mobile device of an individual preparing to load trailer 153, to generate a graphical guide. The graphical guide can include loading UIs that can help the individual load the freight load into trailer 153 of freight vehicle 150.

FIG. 2C illustrates an example method for implementing future load planning when determining an organizational structure of a freight load. In some implementations, for a given freight vehicle (e.g., freight vehicle 150) that is to receive a current freight load, network computer system 100 determines information about a next freight service request that the freight vehicle is to handle (230). By way of example, network computer system 100 can determine a pick-up location, a destination location, information about the next freight load the freight vehicle is to handle from the next freight service request. In some implementations, information about the next freight load can include a listing of items.

In some examples, network computer system 100 can determine that the freight vehicle is to concurrently carry the current freight load and next freight load until one of the freight loads reaches its respective destination (232). The determination can be made by, for example, comparing the destination location associated with the next freight load, or by determining a suitable route between the destination location of the current freight load and the destination location of the next freight load.

Network computer system 100 can determine an organizational structure for loading items of the current freight load within the freight vehicle based in part on the information that is determined about the next freight load (234). In some examples, network computer system 100 can configure or alter the organizational structure for the current freight load based in part on a destination location of the next freight load and/or a planned route between the destination location of the current freight load and the destination location of the next freight load. As an addition or variation, network computer system 100 can determine an organizational structure for the next freight load, and further configure or alter the organizational structure of the current freight load based on characteristics of the organizational structure of the next load.

To illustrate, freight vehicle 150 may be assigned to a first freight service request that specifies a first freight load (“Load A”), a first pickup location (“Pick-up A”), and a first destination location (“Destination A”). Additionally, freight vehicle 150 may also be assigned to a second freight service request that specifies a second freight load (“Load B”), a second pickup location (“Pick-up B”), and a second destination location (“Destination B”). For any one of multiple reasons, it may be desired or required (e.g., by requester deadline) for the freight operator to deliver Load A at its destination (“Destination A”) before delivering the Load B to its corresponding destination (“Destination B”). Under a conventional approach, a freight operator may temporarily unload the items Load B at Destination A, to reach and unload the items of the Load A. Under this approach, the freight operator would have to unload and re-load Load B at Destination A. In contrast, network computer system 100 can implement operations to plan for the route of the freight operator (Destination A before Destination B) when determining the organizational structure of Load A.

In a first illustrative scenario, network computer system 100 generates instructions for loading Load A at a corresponding first pickup location so that Load A is positioned adjacent the trailer's entry door when the Destination A is reached. In determining the organizational structure of Load A, network computer system 100 can earmark or otherwise select items of Load A that can be unloaded or moved within the trailer at the pickup location of Load B, such that the freight operator is able to access and load items of Load B within an interior of the trailer. For example, network computer system 100 can identify certain items of Load A which are lighter and/or more easily moveable, as compared to other items of Load A. The organization structure for Load A can position these selected items alignment within the trailer to form a path. Network computer system 100 can further provide the freight operator with instructions to move or unload the select items of Load A at the second pickup location. In this way, the instructions can be implemented to form a path that the freight operator can use to access an interior space of the trailer, for loading of items of Load B. In determining the organizational structure of Load A, network computer system 100 can use information about the items of Load B to ensure, for example, that a dimension or weight of the items of Load B will permit the use of a path created from movement or unloading of select items of Load A.

In a second illustrative scenario, network computer system 100 generates instructions for loading items of Load B at the second pickup location, with the second freight load being positioned adjacent to the entry door of trailer 153 of freight vehicle 150 when Destination A is reached. In determining the organizational structure for Load B, network computer system 100 can earmark or otherwise select items of Load B that can be unloaded or moved within trailer 153 when the first destination is reached. The selected items of Load B can be arranged such that their movement or removal from trailer 153 forms a path for the freight operator at the Destination A. The freight operator can then form a path amongst the load items of Load B when Load A is to be unloaded at Destination A.

In a third illustrative scenario, network computer system 100 minimizes for width when determining the organizational structure of each of Load A and Load B. At the second pickup location, network computer system 100 can arrange Load A and B to be side-by-side across a width of trailer 153. In such an arrangement, load items of either load is equally accessible for unloading.

As illustrated by such examples, the footprint, height and/or positioning of individual load items of a given freight load can formulate design parameters for use by network computer system 100, from which network computer system 100 can determine organizational structures for sequences of freight loads that freight vehicle 150 can be used to transport. In this way, network computer system 100 can be implemented with or as part of a route planning system, where freight loads and routes can be selected in advance for the freight operator.

FIG. 2D illustrates an example method for matching freight vehicles with freight service requests. In some implementations, network computer system 100 tracks a group of freight vehicles over a duration in which each freight vehicle receives one or more freight loads (240).

In examples, network computer system 100 tracks information about individual freight loads each freight vehicle carries, as well as a current route or destination of the freight vehicle (242). In some examples, the information maintained with some of the freight vehicles can approximate the total shipment weight or volume that the respective freight vehicle is currently carrying, as well as the maximum carrying capacity (e.g., by weight and/or volume) for the freight vehicle. In variations, network computer system 100 can track the amount of free space which the freight vehicle may have available, using, for example, a method such as described by FIG. 2B, performed when the freight vehicle is being loaded.

According to some examples, network computer system 100 may receive a freight service request from a requester (244). Network computer system 100 can obtain, as part of the freight service request, a listing of the items of a freight load the requester is requesting to be transported.

Network computer system 100 can determine information about a size, shape, or weight of each freight item of the freight service request (246). As described with some other examples, the information about the individual items can be determined from, for example, information that is recorded or otherwise stored for the individual items of the freight service request. In some variations, network computer system 100 may communicate with a sensor platform (e.g., sensor platform 154) to receive and record information about the size, shape or weight of the individual items.

Based on the information determined about the individual items, network computer system 100 can determine one or more organizational structures for the freight service request. The organizational structures can vary for alternative design constraints, such as alternative trailer widths or heights. Each organizational structure can be defined in part by a span (or footprint). Additionally, the determined organizational structures can be defined by a height and/or weight.

Network computer system 100 then selects a freight vehicle for the freight service request based in part on a determination that the freight vehicle can accommodate the current freight service request (248). The determination that the freight vehicle can accommodate the current freight service request can be based at least in part on the determined organizational structure of the freight load, as well as current information about what the selected freight vehicle is carrying.

As illustrated by an example of FIG. 2D, network computer system 100 can virtualize freight loads into organizational structures that are optimized for one or more spatial objectives (e.g., minimize free space). Through use of virtual organizational structures, future freight loads of a freight vehicle can be planned. As an addition or variation, freight vehicles can be assigned or otherwise selected for freight loads using a virtualized representation of the freight load. Still further, in other variations, network computer system 100 can publish virtualized representations of freight loads with corresponding freight service requests, to facilitate freight operators in determining whether their respective freight vehicles can accept the freight service requests.

### Warehouse Examples

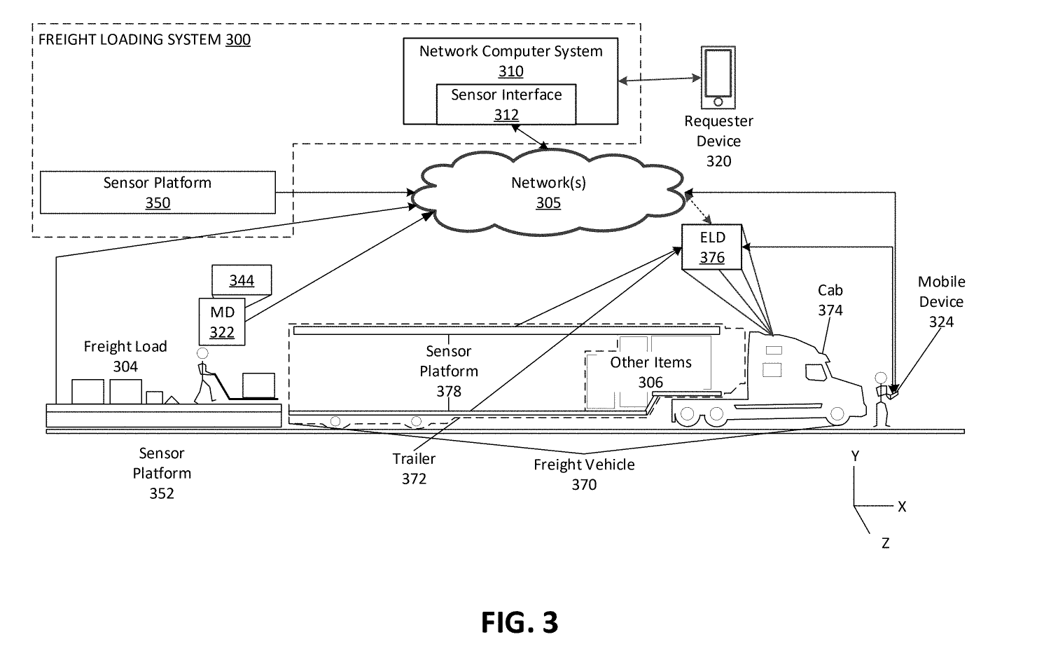

FIG. 3 illustrates an example freight loading system for loading trailers of freight vehicles at loading facilities. An example freight loading system 300 includes at least sensor platform 350 that is located at a loading facility, and network computer system 310 that is in communication with the sensor platform 350 over one or more networks 301. Network computer system 310 can be implemented in accordance with examples such as described with FIG. 1 (e.g., network computer system 100). Network computer system 310 may communicate with sensor platform 350 to determine information about at least a portion of freight load 304 for trailer 372 of freight vehicle 370. Based on the information generated by sensor platform 350, network computer system 310 determines an organizational structure or arrangement for a portion of freight load 304 within trailer 372. In determining the organizational structure, network computer system 310 can generate instructions that specify the stacking and/or positioning of individual items of freight load 304 relative to other items of freight load 304, as well as to other items 306 which may have already been loaded into the trailer.

Network computer system 310 can determine the organizational structure for the freight load to further one or multiple objectives. In examples, network computer system 310 can determine the organizational structure to further objectives that relate to a size-related objective for freight load 304. The size related objective can include, for example, (i) minimizing the amount of free space that remains in trailer 372 (or portion of the trailer) which freight load 304 occupies; (ii) minimizing an amount of volume that is occupied by freight load 304; and/or (iii) adequate distribution of freight load 304 over an interior portion of trailer 372. With the latter objective, the organizational structure of freight load 304 may be accomplished in accordance with a set of predetermined rules, such as (i) a weight distribution rule that distributes items of freight load 304 over a span of trailer 372, such that no predetermined segment of the span has a weight disparity that exceeds a predetermined threshold, as compared to another segment of trailer 372; and/or (ii) a weight verticality rule set to promote stability of freight load 304 (e.g., heavier items are positioned vertically the lowest) or safety (e.g., weight restrictions on the height of items which exceed threshold weights).

In some examples, network computer system 100 can also organize the individual items of freight load 304 in a manner in which individual items of freight load 304 are loaded into trailer 372 of freight vehicle 370 relative to other items of freight load 304, to accommodate a hauling route of the freight operator. In particular, the network computer system 100 can determine the sequence for loading items of freight load 304. The sequencing of the items of freight load 304 can be based on, for example, a target location of the item within trailer 372. The sequencing can also be optimized to reduce, for example, loading time of freight load 304. In some variations, the organizational structure of freight load 304 and/or sequencing can be implemented to minimize unloading time. Still further, the 310 can determine the sequencing to ensure that loading and/or unloading activities for freight load 304 are accomplished within a given window of time.

In some implementations, freight loading system 300 can include sensor platform 352. In such implementations, network computer system 310 can utilize sensor information (e.g., volumetric and/or weight information) generated by sensor platform 352 to determine an organizational structure of each individual item of freight load 304. Network computer system 310 can obtain sensor information generated by sensor platform 352 via network 120. In other implementations, network computer system 310 can utilize item information included in a freight service request from requester device 320 to determine the organizational structure. In various implementations, network computer system 310 can utilize sensor information and item information of a freight service request to determine the organizational structure.

Network computer system 310 can utilize a determined organizational structure for freight load 304 to generate a loading user interface. In such implementations, mobile device 322 and/or 324 can be a part of freight loading system 300. Based on the organizational structure of freight load 304, network computer system 310 can instruct mobile device 322 and/or 324 to generate a graphical guide. The graphical guide can include loading UIs that can help an individual that is loading freight load 304 into trailer 372 of freight vehicle 370. In some implementations, the graphical guide can include one or more tasks or instructions that an individual loading freight load 304 can follow. For example, the graphical guide can indicate which individual item of freight load 304 to first load into trailer 372. Additionally, the graphical guide can indicate where in trailer 372 the individual item should be placed, and in some implementations, how the individual item should be positioned in trailer 372. Based on the organizational structure, network computer system 310 can provide an instruction to mobile device 322 and/or 324 to generate for the loading UI, a graphical representation of where in trailer 372 the individual should place the individual item. Additionally, in some examples, the instruction can also cause mobile device 322 and/or 324 to generate for the loading UI, a graphical representation of how the individual item should be positioned in that particular location of trailer 372.

In some implementations, freight loading system can include sensor platform 378. In such implementations, network computer system 310 can provide loading feedback to an operator or individual loading each individual item of a freight load into trailer 372 of freight vehicle 370. The operator or individual loading each individual item of freight load 304 can view the feedback from mobile device 322 and/or 324. The loading feedback can be based on sensor information generated by sensor platform 378. For example, based on the sensor information generated by sensor platform 378, network computer system 310 can determine weight, volumetric and/or position information of each individual item of freight load 304 loaded into trailer 372. In turn, network computer system 310 can determine whether the operator or individual has loaded each individual item according to the organizational structure determined by network computer system 310. For instance, network computer system 310 can compare the current position information of each individual item loaded into trailer 372 to the determined organizational structure. Based on the positioning of each individual item loaded into the trailer, network computer system 310 can determine whether the individual item was loaded into trailer 372 in the right order, stacking order/position, location inside trailer 372, and/or orientation or position, according to the determined organizational structure. If network computer system 310 determines the individual item of freight load has been loaded incorrectly, network computer system 310 can provide feedback instructions to mobile device 322 and/or 324 to assist the operator or individual to correct that mistake. For example, the feedback instructions can cause mobile device 322 and/or 324 to dynamically update a graphical guide to correcting such a loading error.

In some implementations, network computer system 310 can obtain sensor information of sensor platform 378 directly, through network 120. In other implementations, freight loading system 300 can include ELD 376. In such implementations, network computer system 310 can obtain information from mobile device 322 and/or 324 that includes sensor information of sensor platform 378, through network 120 and from ELD 376. In some examples, the information from mobile device 322 and/or 324 can be generated from ELD 376 that also obtains sensor information of sensor platform 378.

In other implementations, network computer system 310 can utilize sensor information generated by sensor platform 352 and/or sensor platform 378 to determine the loading progress of an operator and/or an individual loading each individual item of freight load 304 into trailer 372. In such implementations, based on the organizational structure, network computer system 310 can determine a set of tasks or steps the operator or individual can follow when loading each individual item of freight load 304 into trailer 372. Additionally, as the operator or individual loads each individual item of freight load 304 into trailer 372, sensor platform 352 can generate sensor information corresponding to the movements of the operator and/or the individual. Based on the sensor information, network computer system 310 can determine the movements the operator and/or individual are making, and whether such movements correspond to the set of tasks network computer system 310 determined from the organizational structure.

For example, based on an organizational structure of freight load 304, network computer system 310 can determine (i) item 1 of freight load 304 should be placed at a particular location in trailer 372, and then (ii) item 2 of freight load 304 should be placed on top. Based on the sensor information, network computer system 310 can determine that the sensor information includes data corresponding to the operator picking up item 1 of freight load 304 and placing item 1 at the particular location of trailer 372. As such, based on the sensor information and the determined set of tasks, network computer system 310 can determine that item 1 of freight load 304 has been loaded into trailer 372, but item 2 of freight load 304 has not. In some implementations, network computer system 310 can present the progress of the operator or individual loading each individual item into trailer 372 on mobile device 322 and/or 324. For example, network computer system 310 can cause mobile device 322 and/or 324 to generate graphical representations indicating the loading progress of the operator and/or individual. In some implementations, as each task or individual item is loaded into trailer 372, network computer system 310 can update records of a corresponding freight service request stored in network computer system 310 (e.g., database 112 and/or service data store 118).

In various implementations, network computer system 310 can transmit loading instructions to a loading device for autonomous loading of individual items of freight load 304. For example, network computer system 310 can utilize a determined organizational structure of freight load 304 when generating loading instructions for the loading device. The loading instructions can cause the loading device to autonomously load the individual items of freight load 304 into trailer 372, according to the determined organizational structure. In such implementations, network computer system 310 can utilize sensor information generated by sensor platform 352 and/or sensor platform 378 to monitor the loading progress of the loading device.

As described with other examples, network computer system 310 can cause mobile device 322 of the operator to generate loading UI 344 to guide the freight operator in locating items of the freight load, and also in loading the individual items into the trailer in accordance with a predetermined sequence that correlates to the planned organizational structure for the freight load. Once an item is placed in the trailer, the sensor platform can confirm the placement, and then, through instructions provided by loading UI 344, guide the operator to the next item of the freight load.

In examples, sensor platform 350 can also be used to detect a deviation between how a given item of a freight load is placed in the trailer and how the item should have been placed or positioned within the trailer, based on the planned organizational structure of the freight load. A detected deviation may correspond to, for example, the given item being slightly misplaced within the trailer (e.g., placed in the correct position, but not aligned fully as expected), a loaded item being placed in the wrong position within the trailer (e.g., placed in position where other item of freight load is to be placed), and/or a loaded item being improperly aligned or skewed (e.g., not properly rotated, as planned). In some examples, network computer system 310 detects a deviation in the placement of individual items within the trailer, at least as compared to an expectation of the planned organizational structure. Network computer system 310 can accommodate the detected deviation by reevaluating the planned organizational structure of the freight load, at least with respect to remaining items that have not yet been loaded. In this manner, network computer system 310 can adjust or otherwise change the organizational structure of a freight on-the-fly, by detecting unplanned changes with respect to how individual items are loaded in the trailer of the freight vehicle.

Once an individual item is loaded into the trailer, network computer system 310 communicates with sensor platform 350 to determine information about the next item (e.g., an identifier corresponding to the next item or images of the exterior of the next item) of the freight load that is to be loaded into trailer 372. In some variations, loading UI 344 can be used to automatically detect and indicate to the freight operator individual items of the freight load which are to be loaded into the trailer in accordance with a predetermined sequence. For example, once the operator loads a given item into the trailer, network computer system 310 can programmatically process sensor data (including image data rendered by the mobile device) to detect the item of the freight load that is to be loaded into the trailer next. In some variations, the detection of individual items which the freight operator is to load as a next action can be done programmatically, based on, for example, processing image and/or other sensor data, as well as identifying information about the individual items from the manifest of the freight load. In this way, network computer system 310 can cause mobile device 322 to generate visual cues and markers that graphically indicate a subject of the operator's next action.

Example User Interfaces

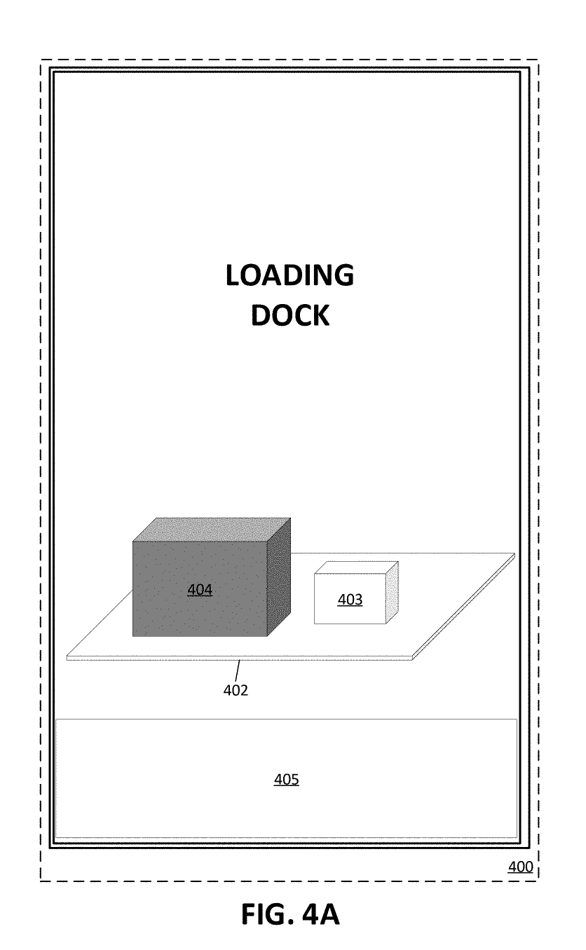

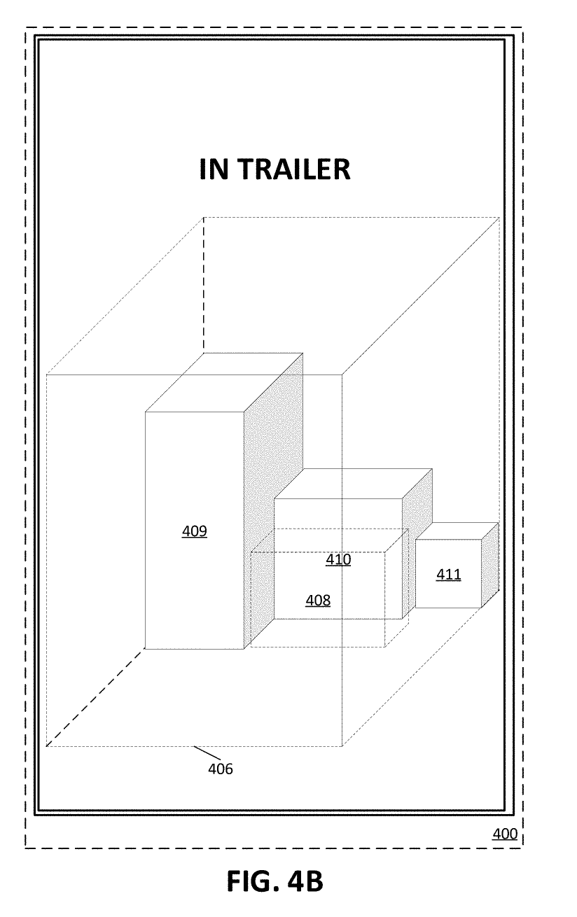

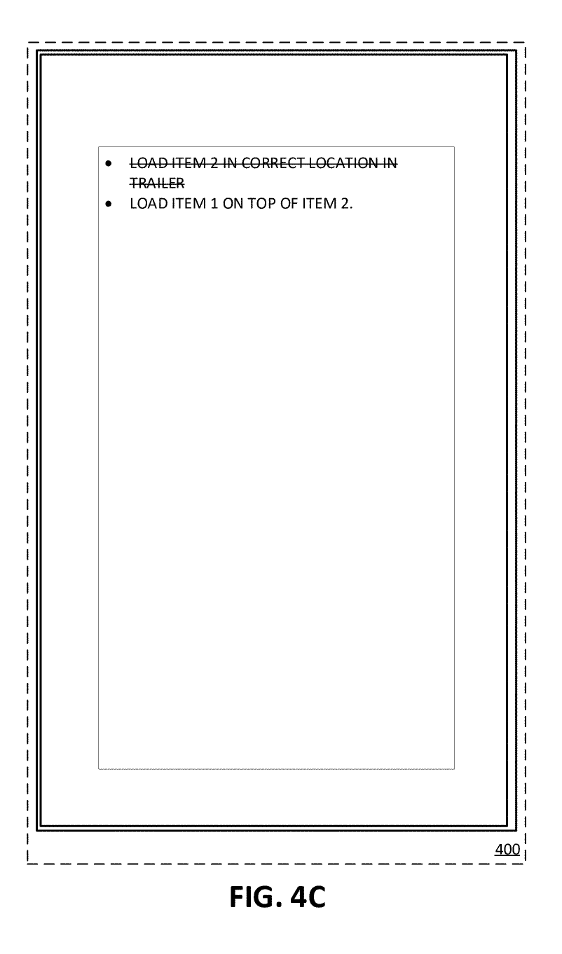

FIG. 4A through FIG. 4C illustrate example loading user interfaces for facilitating operators in loading items of a freight load in accordance with a predetermined organizational structure. In describing examples of FIGS. 4A-4C, reference may be made to reference characters representing like features as shown and described with respect to FIG. 1 for purpose of illustrating a suitable component associated with generating the example loading UIs.

FIG. 4A illustrates an example loading UI that indicates which individual item of a freight load to load into a freight vehicle. As illustrated in FIG. 4A, loading UI 400 can present a graphical representation 402 of a loading dock of freight load facility 151, graphical representation 403 of item 1 of a freight load and graphical representation 404 of item 2 of the freight load. In some implementations, network computer system 100 can cause mobile device 140 to generate loading UI 400 that indicates which individual item of a freight load to load into trailer 153. For example, based on an organizational structure of a freight load, item 2 has been determined to be loaded first (e.g., item 2 is heavier than item 1). As such, network computer system 100 can instruct mobile device 140 to indicate on loading UI 400 of service application 145, for example by highlighting, graphical representation 404. Other examples of indicating which individual item of a freight load to load into a freight vehicle include, coloring graphical representation 404 differently from graphical representation 403 and utilizing a graphic (e.g., an arrow) pointing to graphical representation 404.

Additionally, or alternatively, the loading user interface of service application 145 can include panel 405. Panel 405 can include information related to helping an operator and/or individual loading each individual item of a freight load, identify which individual item to load next. For example, panel 405 can include information related to the shape, size and visible identifiers (e.g., a barcode, alphanumeric identifier, etc.) that are located on said individual item.

FIG. 4B illustrates an example loading UI indicating a particular location an individual item of a freight load is to be placed in a freight vehicle. As illustrated in FIG. 4B, loading UI 400 can include graphical representation 406 of trailer 153. Additionally, loading UI 400 can include graphical representations 409, 410 and 411 of individual items of a freight load already loaded into trailer 153. Moreover, loading UI 400 can include graphical representation 408 indicating where an operator and/or individual can place the individual item in trailer 153. In some implementations, network computer system 100 can cause mobile device 140 to indicate on loading UI 400 of service application 145 how the individual item is to be positioned in trailer 153. Examples of indicating how the individual item is to be positioned in trailer 153 includes, highlighting the graphical representation 408, coloring the graphical representation 408 and/or utilizing a graphic (e.g., an arrow) pointing to graphical representation 408.

FIG. 4C illustrates an example loading UI indicating a loading progress of an operator and/or individual loading each individual item of a freight load into the freight vehicle. The loading progress can be based on a set of tasks determined from the organizational structure and sensor information from sensor platform 154 and sensor platform 155. For example, based on the organizational structure of a freight load, network computer system 100 can determine (i) item 2 of a freight load should be placed at a particular location in trailer 153, then (ii) item 1 of the freight load should be placed on top, (iii) load item 3 next to item 2 in correct location, and (iv) load item 4 on top of item 3 and next to item 1. Additionally, based on the sensor information, network computer system 100 can determine that the sensor information includes data corresponding to the operator and/or individual picking up item 2 of the freight load and placing item 2 at the particular location of trailer 153. As such, network computer system 100 can determine that item 2 of the freight load has been loaded into trailer 153, but item 1, 3 and 4 of the freight load have not. In some implementations, as network computer system 100 can cause mobile device 140 to present the loading progress of the operator and/or individual loading each individual item into trailer 153. In some examples, as illustrated in FIG. 4C such loading progress can be presented in list form.

In some implementations, network computer system 100 can coordinate a presentation of various loading UIs on service application 145 running on mobile device 140, based on the progress of an operator and/or an individual in loading each individual item of a freight load into a freight vehicle. For example, based on an organizational structure of a freight load, as the operator goes to pick up each individual item of the freight load and places said item into trailer 153, network computer system 100 can cause mobile device 140 to generate and present various loading UIs at various instances to help guide the operator or individual in loading the individual items.

For example, a particular item has not been moved from the loading dock of freight load facility 151. Based on sensor information sensor information generated by sensor platform 154, network computing system 100 can determine the particular item has yet to be moved from the loading dock of freight load facility 151. In response to such a determination, network computer system 100 can cause mobile device 140 to generate and present a first loading UI that indicates which of the individual items of a freight load is the particular item. FIG. 4A illustrates such an example loading UI.

In another example, a particular item has been moved from the loading dock and is traveling to trailer 153. Based on sensor information sensor information generated by sensor platform 154, network computing system 100 can determine the particular item has been picked up. In response to such a determination, network computer system 100 can cause mobile device 140 to generate and present a second loading UI that indicates the particular location and/or position that the operator and/or individual should place the particular item in trailer 153. In such an example, network computer system 100 can cause mobile device 140 to generate and present the second loading UI after the first loading UI, in response to network computer system 100 determining the particular item has been picked up. An example of the second loading UI is illustrated in FIG. 4B.

In some examples, as each individual item has been loaded, network computer system 100 can cause mobile device 140 to generate a loading UI that can indicate which individual items of the freight load that have been loaded into trailer 153. For example, based on sensor information sensor information generated by sensor platform 155, network computing system 100 can determine the particular item been loaded correctly into trailer 153. In response to such a determination, network computer system 100 can cause mobile device 140 to generate and present a third loading UI. The third loading UI can indicate that the particular item, and any other individual items of the freight load, has been loaded into trailer 153. In such an example, network computer system 100 can cause mobile device 140 to generate and present the third loading UI after the second loading UI, in response to network computer system 100 making such a determination. An example of the second loading UI is illustrated in FIG. 4C.

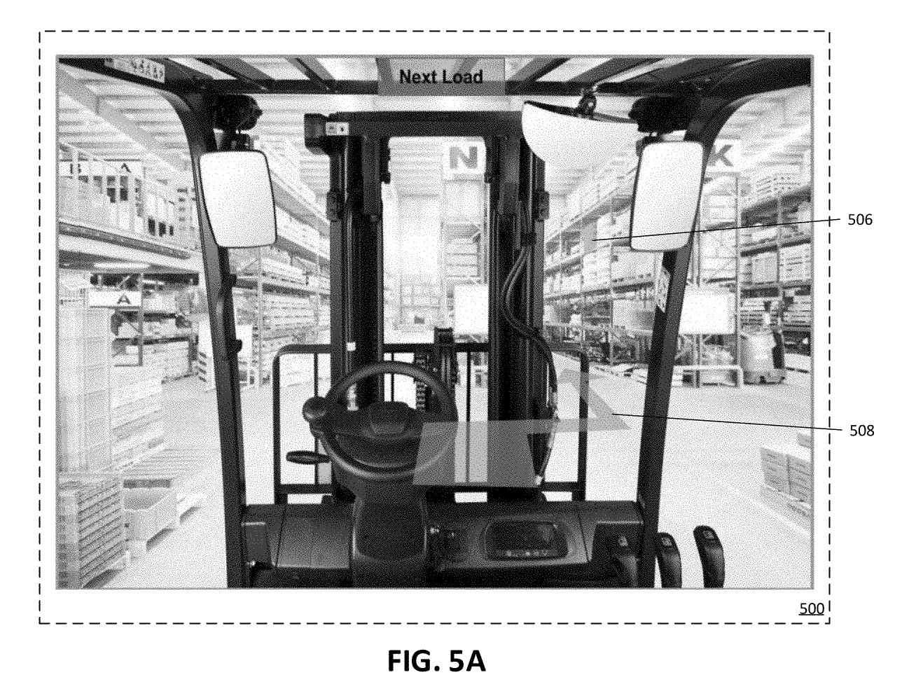

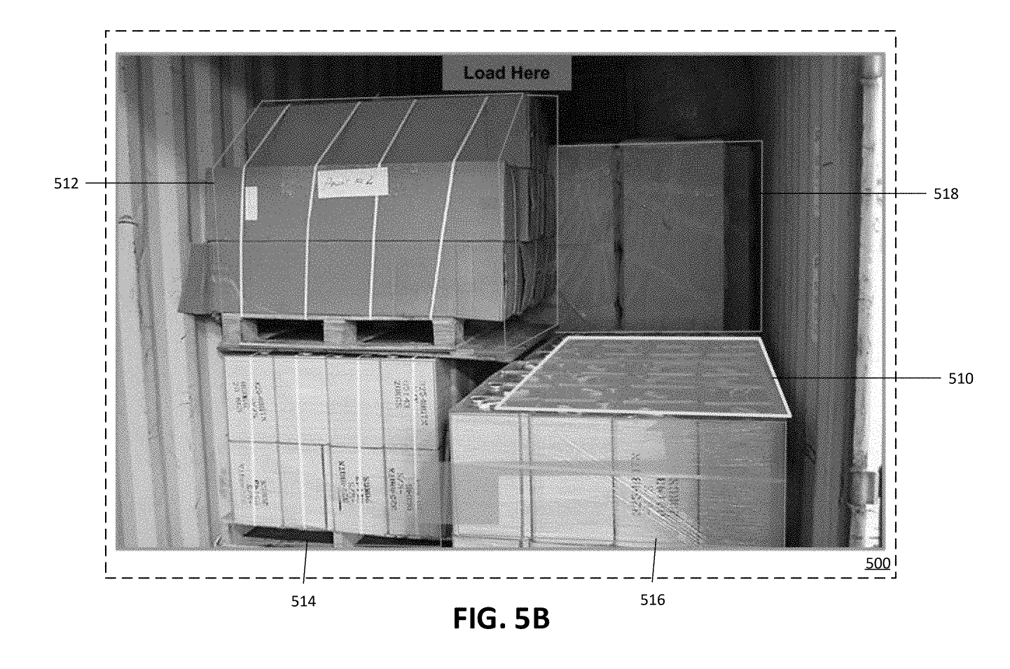

FIG. 5A and FIG. 5B illustrate alternative states of an example loading UI that utilizes augmented reality to communicate loading instructions to an operator at a shipping facility. In the below discussions of FIG. 5A and FIG. 5B, reference may be made to reference characters representing like features as shown and described with respect to FIG. 3 for purpose of illustrating a suitable component associated with generating loading UI 500, as shown and described with FIG. 5A and FIG. 5B.

As described, loading UI 500 can provide various types of instructions to an operator, such as a set of end-to-end instructions which guide the operator in locating and/or selecting individual items of the freight load at the shipper facility, as well as placing the individual items at target locations within the trailer. In providing instructions to the operator, loading UI 500 can transition through multiple states, such as (i) item location state, where loading UI 500 generates visual indicators to locate an item of the freight load for the user, (ii) item loading state, where loading UI 500 generates visual indicators to facilitate loading of an item in a trailer, and (iii) a transition state, where loading UI 500 transitions to rendering visual indicators for a next action that the freight operator is to perform (e.g., loading a preselected next item in trailer). In some implementations, loading UI 500 can include an image layer (e.g., video) and one or more virtual layers. The image layer of loading UI 500 can be generated by a camera, which can be provided as part of sensor platform 350 and/or mobile device 322 of the operator.

In some examples, loading UI 500 can render a video feed, corresponding a real-time view point of the camera of the mobile device 322, on which one or more graphical representations of individual items of the freight load loading UI 500 can be layered over. The graphical representations can also depict aspects of the shipping facility and/or an interior of the trailer. Still further, the graphical representations can be rendered as multiple layers over the image layer.

FIG. 5A illustrates an item location state in which one or more graphical overlays can illuminate or otherwise visually mark an item of a freight load that is to be loaded by the freight operator at a current instance. In some implementations, network computer system 310 can cause mobile device 322 of the operator to generate graphical overlay 506 on loading UI 500, where the graphical overlay 506 identifies a specific item that is to be loaded into the trailer, in accordance with a desired organization structure for a corresponding freight load. Graphical overlay 506 can also identify a specific location within a freight loading facility of a shipper where a particular item is located. For example, graphical overlay 506 can visually indicate (e.g., through blinking, highlighting, or other visual effect) to the operator the specific item of a freight load the operator or individual should load next into the trailer.

Network computer system 310 can, for example, correlate an identifier of the item that is to be loaded with the item's location within the shipping facility. In such examples, loading UI 500 can render navigational instructions to facilitate the operator in locating the item at the shipper's facility. The navigational instructions may identify, for example, a heading and/or elevation for an item that is to be loaded as part of the freight load. Loading UI 500 can also include graphical overlay 508 to indicate a heading or general direction for the operator to use in locating the specific item of the freight load.

FIG. 5B illustrates loading UI 500 in an item loading state. In the item loading state, loading UI 500 can display a portion of an interior of the trailer (e.g., as image data). Prior to an item being placed, loading UI 500 can display overlay 510 to indicate the target location in the trailer where the next item is to be placed. As described by other examples, the target location can be determined by the organizational structure of the freight load, as determined by the network computer system 100.

Once an item of a freight load is placed in the trailer, in accordance with a predetermined organizational structure, sensor platform 350 can be used to confirm placement, detect deviation as between the actual placement and the planned placement, reevaluate the sequencing or loading plan for the remaining items of the freight load as necessary. With reference to an example of FIG. 5B, sensor platform 350 may measure, for example, a boundary for one or more previously placed item 512, 514, 516 to determine if the placed item was misplaced, positioned in skew, or positioned in the wrong place. Moreover, to facilitate the freight operator in maneuvering the loaded item, loading UI 500 may generate the boundary to aid the operator in delineating the existing portion of the freight load from a newly loaded set of items.

In the transitional state, network computer system 310 may operate to identify a next item that the operator should load. The identification can be made in accordance with a predetermined organizational structure. Alternatively, the identification of the next item can be made in response to a deviation of the planned loading for a portion of the freight load (e.g., item misplaced or positioned incorrectly).

While many examples are described above in context of a mobile device, specific examples provide for use of immersive devices by operators when loading items for a freight load. Examples of immersive devices include headsets or goggles with augmented-reality resources.

Hardware Diagram

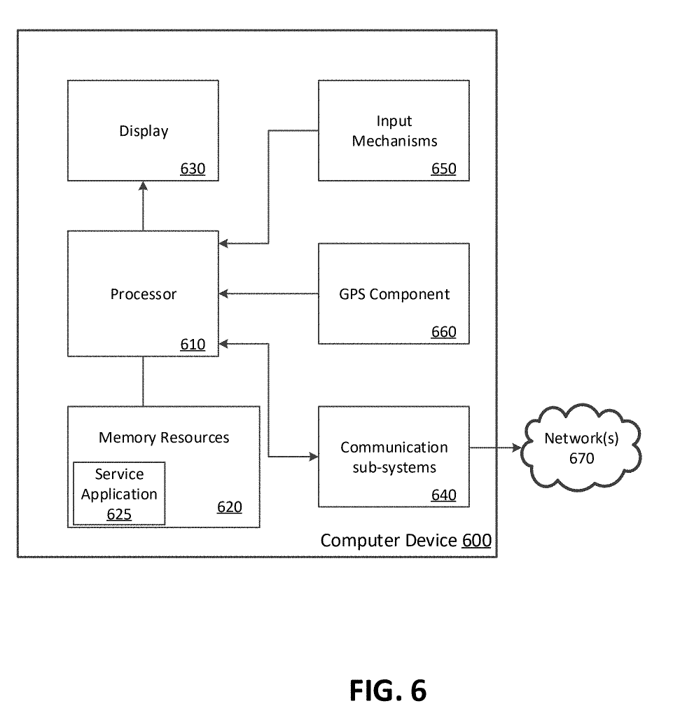

FIG. 6 is a block diagram that illustrates a mobile device upon which examples described herein may be implemented. In one embodiment, mobile device 600 may correspond to, for example, a cellular device that is capable of telephony, messaging, and data services. In other examples, the mobile device 600 may correspond to an immersive-type computing device, such as an augmented-reality headset or wearable goggle device. The mobile device 600 can correspond to a device operated by a requester or, in some examples, a device operated by the service provider (e.g., a freight operator) that provides location-based services. Examples of such devices include smartphones, handsets, tablet devices, or in-vehicle computing devices that communicate with cellular carriers. The mobile device 600 includes processor 610, memory resources 620, display component 630 (e.g., such as a touch-sensitive display device), one or more communication sub-systems 640 (including wireless communication systems), one or more input mechanisms 650 (e.g., accelerometer and/or gyroscope, microphone, barometer, etc.), and one or more location detection components (e.g., GPS component) 660. In one example, at least one communication sub-system 640 sends and receives cellular data over network(s) 670 (e.g., data channels and voice channels). Communication sub-systems 640 can include a cellular transceiver and one or more short-range wireless transceivers. Processor 610 can exchange data with a service arrangement system (not illustrated in FIG. 6) via the one or more communications sub-systems 640 and over network(s) 670.

Processor 610 can provide a variety of content to display component 630 by executing instructions stored in memory resources 620. Memory resources 620 can store instructions for service application 648. For example, processor 610 can execute the service application 648 to read data from one or more input mechanisms 650 of the computing device, and to transmit the data, along with location data of GPS component 660 as local device data to a network computer system (e.g. network computer system 100).

In examples, processor 610 can retrieve from memory resources 620 instructions for executing a service application 648. As described with other examples, service application 648 can enable an operator to receive information about an organizational structure of a freight load. Additionally, service application 648 can execute to generate one or more user interfaces, such as a loading UI, as shown by examples of FIG. 4A through FIG. 4C and FIG. 5A and FIG. 5B.

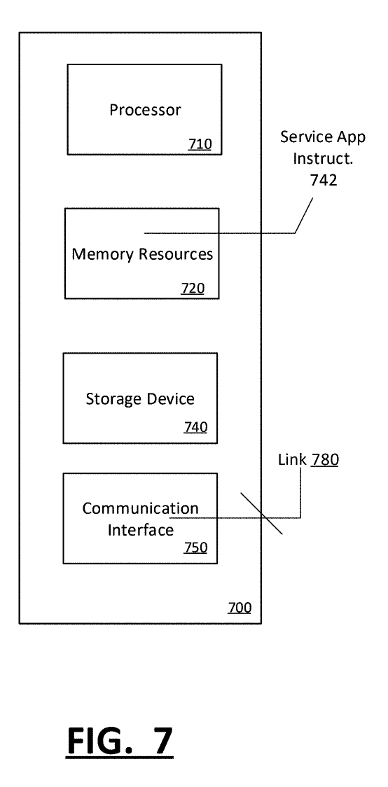

FIG. 7 illustrates a computer system on which one or more example network computer systems can be implemented. Computer system 700 can be implemented on, for example, a server or combination of servers. For example, computer system 700 may be implemented as a server for a network computer system, such as shown and described with an example of FIG. 1 and with an example of FIG. 3. Likewise, computer system 700 can implement a method such as described with examples of FIG. 2A through FIG. 2D.

In one implementation, computer system 700 includes processing 710, memory resources 720 (e.g., read-only memory (ROM) or random-access memory (RAM)), a storage device 740, and a communication interface 750. Computer system 700 includes at least one processor 710 for processing information stored in memory resources 720, such as provided by a random-access memory (RAM) or other dynamic storage device, for storing information and instructions which are executable by processor 710. Memory resources 720 also may be used for storing temporary variables or other intermediate information during execution of instructions to be executed by processor 710. Computer system 700 may also include memory resources 720 or other static storage device for storing static information and instructions for processor 710. Storage device 740, such as a magnetic disk or optical disk, is provided for storing information and instructions.

Communication interface 750 enables Computer system 700 to communicate with one or more networks (e.g., cellular network) through use of network link 780 (wireless or a wire). Additionally, computer system 700 can utilize network link 780 to communicate with one or more computing devices, specialized devices and modules, and one or more servers. The executable instructions stored in memory resources 720 can include instructions 742, to implement a network computing system such as described with an example of FIG. 1 or FIG. 3. The executable instructions stored in memory resources 720 may also implement a method, such as described with one or more examples of FIG. 2A through FIG. 2D.

As such, examples described herein are related to the use of computer system 700 for implementing the techniques described herein. According to an aspect, techniques are performed by computer system 700 in response to processor 710 executing one or more sequences of one or more instructions contained in memory resources 720. Such instructions may be read into memory resources 720 from another machine-readable medium, such as storage device 740. Execution of the sequences of instructions contained in memory resources 720 causes processor 710 to perform the process steps described herein. In alternative implementations, hard-wired circuitry may be used in place of or in combination with software instructions to implement examples described herein. Thus, the examples described are not limited to any specific combination of hardware circuitry and software.

Examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computer system comprising:
one or more processors;
a set of memory resources to store instructions that, when executed by the one or more processors, cause the network computer system to:
communicate, over one or more networks, with a sensor platform that includes one or more sensors to obtain sensor information of at least a portion of a freight load;
evaluate at least the portion of the freight load for at least one of size, shape or weight, based on the sensor information;
based on evaluating at least the portion of the freight load, determine an organizational structure for at least the portion of the freight load within a freight container;
generate a set of instructions for loading individual items of at least the portion of the freight load in the freight container in accordance with the organizational structure; and
transmit, over the one or more networks, data corresponding to the set of instructions to a computing device of an operator, the transmitted data causing the computing device to generate a graphical guide that identifies, based on the set of instructions, a location within the freight container where an item of the freight load is to be placed by the operator.

2. The network computer system of claim 1, wherein the one or more processors execute the instructions to associate individual items of the freight load with sensor information obtained from the sensor platform.

3. The network computer system of claim 1, wherein the one or more processors evaluate at least the portion of the freight load by (i) obtaining a list of individual items of the freight load, and for at least some of the individual items, (ii) retrieving stored information that identifies at least one of the size, shape or weight of the item.

4. The network computer system of claim 1, wherein the one or more processors determine the organizational structure for the freight load to optimize for a size-related objective of the freight load.

5. The network computer system of claim 1, wherein the one or more processors determine the organizational structure for the freight load to minimize an amount of free space within the freight container once the freight load is loaded.

6. The network computer system of claim 1, wherein the one or more processors determine the organizational structure for the freight load to optimize distribution of a weight of the freight load within the freight container.

7. The network computer system of claim 1, wherein the one or more processors determine the organizational structure for the freight load to minimize an interval of time for subsequently unloading at least the portion of the freight load.

8. The network computer system of claim 1, wherein the one or more processors determine the organizational structure for the freight load to specify a sequence in which individual items of the freight load are to be loaded into the freight container.

9. The network computer system of claim 1, wherein the one or more processors determine the organizational structure for the freight load to specify a location within the freight container where the individual items of the freight load are to be loaded.

10. The network computer system of claim 1, wherein the transmitted data causes the computing device to indicate, on the graphical guide, (i) each of multiple items of the freight load that have yet to be loaded into the freight container, and (ii) for each of the multiple items, identify a corresponding location within the freight container where the item is to be placed by the operator.

11. A freight loading system comprising:
a sensor platform that includes one or more sensors to sensor information about at least one of a size, shape or weight of at least a portion of a freight load; and
a network computer system to:
receive the sensor information;
based at least in part on the sensor information, determine an organizational structure for at least the portion of the freight load within a freight container of a freight vehicle; and
generate a set of instructions for loading individual items of at least the portion of the freight load in the freight container in accordance with the organizational structure; and
transmit, over the one or more networks, data corresponding to the set of instructions to a computing device of an operator, the transmitted data causing the computing device to generate a graphical guide based that identifies, based on the set of instructions, a location within the freight container where an item of the freight load is to be placed by the operator.

12. The freight loading system of claim 11, wherein the one or more sensors includes at least one of an ultrasonic sensor, infrared sensor, LIDAR, or radar.

13. The freight loading system of claim 11, further comprising:
one or more sensor interfaces to communicate with a set of sensors of the freight container or freight vehicle; and
wherein the network computer system determines the organizational structure based at least in part on sensor information obtained from the one or more sensor interfaces communicating with the set of sensors of the freight container or freight vehicle.

14. The freight loading system of claim 13, wherein the network computer system determines an amount of free space within the freight container before and/or during when the freight load is being loaded into the freight container.

15. The freight loading system of claim 14, wherein the network computer system determines the organizational structure for the freight load to optimize for a size-related objective of the freight load based at least in part on the determined amount of free space.

16. The freight loading system of claim 11, wherein the network computer system generates the set of instructions to specify a sequence of individual items of the freight load that are to be loaded into the freight container.

17. The freight loading system of claim 11, wherein the network computer system generates the set of instructions to specify a location of individual items of the freight load that are to be loaded into the freight container.

18. The freight loading system of claim 11, wherein at a given instance, the client application indicates on the graphical guide (i) a first individual item of the freight load to load into the freight container, and (ii) where in the freight container to place the first individual item of the freight load.

19. A method for evaluating freight loads, the method being implemented by one or more processors and comprising:
communicating, over one or more networks, with a sensor platform that includes one or more sensors to obtain sensor information of at least a portion of a freight load;
evaluating at least the portion of the freight load for at least one of size, shape or weight, based on the sensor information;
based on evaluating at least the portion of the freight load, determining an organizational structure for at least the portion of the freight load within a freight container;
generating a set of instructions for loading individual items of at least the portion of the freight load in the freight container in accordance with the organizational structure; and
transmitting, over the one or more networks, data corresponding to the set of instructions to a mobile computing device of an operator, the transmitted data causing to cause a client application executing on the mobile the computing device to generate a graphical guide based that identifies, based on the set of instructions, a location within the freight container where an item of the freight load is to be placed by the operator.

20. The method of claim 19, further comprising:
associating individual items of the freight load with sensor information obtained from the sensor platform.
